(19) United States
(12) Patent Application Publication
(10) Pub. No.: US 2026/0237567 A1
(43) Pub. Date: Aug. 13, 2026

(54) ELECTROLYTIC CAPACITOR ELEMENT AND ELECTROLYTIC CAPACITOR

(71) Applicant: ELNA CO., LTD., Chuo-ku, Tokyo (JP)

(72) Inventors: Kaoru AMAHA, Nishishirakawa-gun, Fukushima (JP); Kazuki YAMADA, Nishishirakawa-gun, Fukushima (JP); Hidenori SOMEI, Nishishirakawa-gun, Fukushima (JP)

(21) Appl. No.: 19/151,810

(22) PCT Filed: Jan. 18, 2024
(86) PCT No.: PCT/JP2024/001313

§ 371 Date: Jul. 29, 2025

(30) Foreign Application Priority Data
Feb. 17, 2023 (JP) 2023-023557

(51) Int. Cl. H01G 9/028; H01G 9/02; H01G 9/035; H01G 9/15

(52) U.S. Cl. CPC H01G 9/028; H01G 9/02; H01G 9/035; H01G 9/151

(57) ABSTRACT

An electrolytic capacitor element of an embodiment of the present invention includes a separator impregnated with a conductive polymer, and an anode foil and a cathode foil facing each other via the separator, in which at an end portion of the separator, a band-shaped agglomerate of the conductive polymer, having a width of 3 mm or less, is formed along the end portion.

### TECHNICAL FIELD

The present invention relates to an electrolytic capacitor element and an electrolytic capacitor.

### BACKGROUND ART

It is known that an electrolytic capacitor includes an anode foil, a cathode foil, and a separator and is produced by immersing a wound body in an electrolyte solution, the wound body including a conductive polymer film formed on a surface of the anode foil where a dielectric layer is formed. This type of electrolytic capacitor is called a hybrid electrolytic capacitor, is small in size and large in capacitance, has a low equivalent series resistance (ESR), and is widely used, for example, as vehicle-mounted electronic components.

For example, Patent Literatures 1 and 2 each disclose that in the production of a hybrid electrolytic capacitor, an electrolytic capacitor element is immersed in a dispersion liquid or solution of a conductive polymer (hereinafter, referred to as a conductive polymer liquid) in such a manner that a separator is impregnated with the conductive polymer.

### Background Art Literature

### Patent Literature

Patent Literature 1: Japanese Unexamined Patent Application Publication No. 2019-516241
Patent Literature 2: U.S. Pat. No. 8,462,484

### SUMMARY OF THE INVENTION

### Problems to be Solved by the Invention

However, sufficient impregnation with a conductive polymer is difficult after the formation of an electrolytic capacitor element. It is difficult to uniformly form the polymer layer in the capacitor element where the electrode foils that sandwich a separator face each other, resulting in unevenness. In this case, in a region closer to the middle portion of the separator, the conductive polymer is less present, and the electrical resistance is higher.

As a result, it is difficult to sufficiently reduce the ESR of the electrolytic capacitor. Furthermore, there is a possibility that an electrolyte solution supplemented in a portion where the conductive polymer layer is not formed evaporates, and the portion no longer contributes to the capacity, leading to a deterioration in the properties of the capacitor.

The present invention has been made in view of the above-described problems, and it is an object of the present invention to provide an electrolytic capacitor element and an electrolytic capacitor, both of which can inhibit the uneven formation of a conductive polymer layer and can reduce the ESR.

### Means for Solving the Problems

An electrolytic capacitor element of the present invention is characterized by including a separator impregnated with a conductive polymer, and an anode foil and a cathode foil facing each other with the separator interposed therebetween, in which at an end portion of the separator, a band-shaped agglomerate of the conductive polymer, having a width of 3 (mm) or less, is formed along the end portion.

In the electrolytic capacitor element described above, the separator, the anode foil, and the cathode foil may be wound in a predetermined direction, and at another end portion opposite to the end portion in a direction roughly orthogonal to the predetermined direction, another band-shaped agglomerate of the conductive polymer having a width of 3 mm or less may be formed along the another end portion.

In the electrolytic capacitor element described above, the agglomerate of the conductive polymer formed on the separator may have a width of 2 mm or less.

In the electrolytic capacitor element described above, the agglomerate of the conductive polymer formed on the separator may have a width of 1 mm or less.

In the electrolytic capacitor element described above, the band-shaped agglomerate of the conductive polymer may be attached to the anode foil along the end portion.

In the electrolytic capacitor element described above, the band-shaped agglomerate of the conductive polymer may be attached to the cathode foil along the end portion.

An electrolytic capacitor of the present invention includes the electrolytic capacitor element described above.

### Effects of the Invention

According to the present invention, it is possible to inhibit the uneven formation of the conductive polymer layer of the electrolytic capacitor element and reduce the ESR of the electrolytic capacitor.

### BRIEF DESCRIPTION OF DRAWINGS

FIG. 1 is a side view illustrating an example of an aluminum electrolytic capacitor.

FIG. 2 is a perspective view illustrating an example of an electrolytic capacitor element.

FIG. 3 is a cross-sectional view illustrating a part of a cross-section taken along line A-A in FIG. 2.

FIG. 4 is a cross-sectional view illustrating a part of a cross-section taken along line A-A in FIG. 2 when conductive polymer layers are not sufficiently formed.

FIG. 5A is a plan view illustrating a surface of a separator when ESR is high.

FIG. 5B is a plan view illustrating a surface of a separator when ESR is low.

FIG. 6A is a plan view illustrating an anode foil decomposed from a wound body.

FIG. 6B is a plan view illustrating a cathode foil decomposed from a wound body.

FIG. 7 is a flowchart illustrating an example of a production process for an aluminum electrolytic capacitor.

FIG. 8 is a diagram illustrating a method for immersing an electrolytic capacitor element.

FIG. 9 is a cross-sectional view of a wound body and illustrates an example of a state in which separators are impregnated with a dispersion liquid of a conductive polymer in a reduced-pressure holding step.

FIG. 10 is a cross-sectional view illustrating an example of a wound body in which separators are not sufficiently impregnated with a dispersion liquid.

FIG. 11 is a cross-sectional view of a wound body and illustrates an example of the impregnation state of a dispersion liquid when an open-to-atmosphere step is started with the formation of the accumulation region of nanoparticles inhibited.

FIG. 12 is a cross-sectional view illustrating an example of a wound body in which separators are ideally impregnated with a dispersion liquid.

### MODE FOR CARRYING OUT THE INVENTION

### Embodiments

### (Configuration of Aluminum Electrolytic Capacitor)

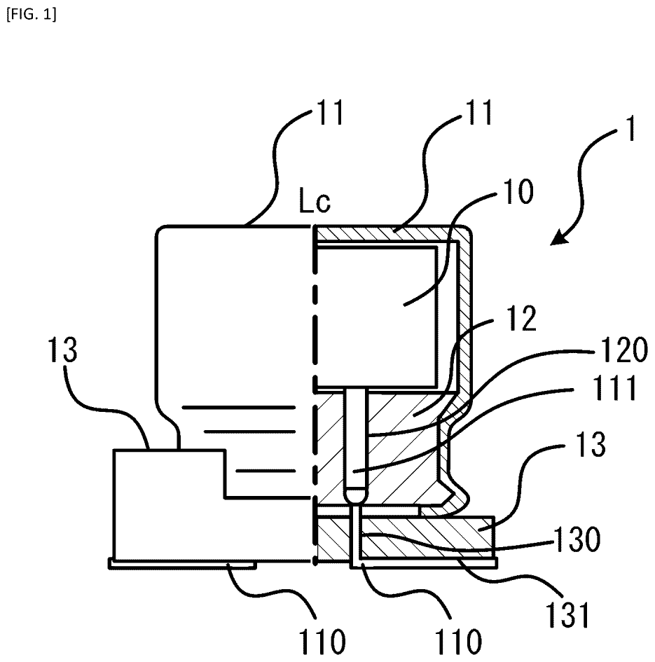

FIG. 1 is a side view illustrating an example of an aluminum electrolytic capacitor. On the paper surface of FIG. 1, the right half of an aluminum electrolytic capacitor 1 with respect to a center line Lc illustrates a section of its interior.

The aluminum electrolytic capacitor 1 is an example of an electrolytic capacitor, and specifically, is a conductive polymer hybrid aluminum electrolytic capacitor. The aluminum electrolytic capacitor 1 is mounted on an electronic circuit board and is used, for example, for coupling, decoupling, smoothing, and the like.

The aluminum electrolytic capacitor 1 includes an electrolytic capacitor element 10, a case 11, a sealing body 12, a seat plate 13, a pair of round rod portions 111, and a pair of lead portions 110. The round rod portions 111 and the lead portions 110 are extraction electrodes of the electrolytic capacitor element 10, and the lead portions 110 extend from the respective tips of the round rod portions 111. It should be noted that although only one round rod portion 111 is illustrated in FIG. 1, the other round rod portion 111 is provided at a symmetrical position with respect to the center line L.

The case 11 is made of aluminum and has a cylindrical shape having a closed upper opening. The case 11 covers the electrolytic capacitor element 10 and the sealing body 12 and functions as an exterior of the aluminum electrolytic capacitor 1. It should be noted that the shape of the case 11 is not limited to the cylindrical shape, but may be a polygonal cylinder shape.

The sealing body 12 is a roughly columnar shape member made of an elastic material, such as butyl rubber. The sealing body 12 is adjacent to the electrolytic capacitor element 10 and seals an opening in the lower portion of the case 11.

As described below, the electrolytic capacitor element 10 has a configuration in which an anode foil, a cathode foil, and a separator (electrolytic paper) are stacked and wound in a predetermined direction. The pair of round rod portions 111 extends from the bottom portion of electrolytic capacitor element 10.

The round rod portions 111 and the lead portions 110 are bar-like members made of aluminum or the like. The pair of round rod portions 111 is joined to the respective anode and cathode foils by joining means, such as caulking, and functions as the respective anode and cathode terminals of the aluminum electrolytic capacitor 1. Each round rod portion 111 is inserted through a respective one of a pair of through holes 120 formed in the sealing body 12. It should be noted that although only one through hole 120 is illustrated in FIG. 1, the other through hole 120 is provided at a symmetrical position with respect to the center line L.

Each lead portion 110 has a flat plate shape and is bent in an L-shape, and its tip end side portion extends along the plate surface of the seat plate 13. A portion of each lead portion 110 adjacent to a respective one of the round rod portions 111 is inserted through a through hole 130 of the seat plate 13. The lead portions 110 are soldered to pads on an electronic circuit board during a reflow process for the electronic circuit board.

The seat plate 13 is a plate-shaped member made of a resin or the like, and is provided at the lower portions of the case 11 and the sealing body 12. The seat plate 13 supports the case 11 and the sealing body 12 for the electronic circuit board on which they are to be mounted. The seat plate 13 is provided with the through holes 130 for the lead portions 110 and groove parts 131 for housing the bent tip areas of the lead portions 110. Each of the groove parts 131 extends outward from the vicinity of the center along the bottom surface of the seat plate 13. Since the bottom surface of the seat plate 13 serves as a mounting face of the aluminum electrolytic capacitor 1 on the electronic circuit board, the plate-shaped lead portions 110 can be soldered to the pads on the electronic circuit board. It should be noted that in the present embodiment, a surface mount type aluminum electrolytic capacitor 1 is described. However, examples described below can also be applied to a lead type without the seat plate 13.

### (Configuration of Electrolytic Capacitor Element)

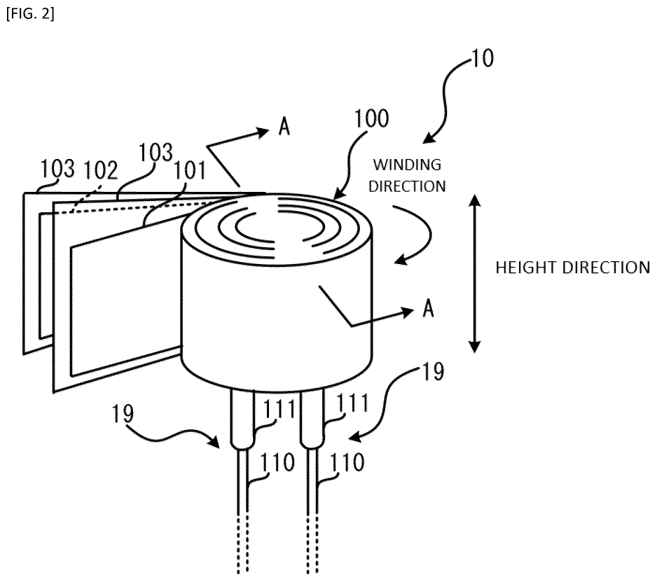

FIG. 2 is a perspective view illustrating an example of the electrolytic capacitor element 10. In FIG. 2, the same components as those in FIG. 1 are denoted by the same reference numerals, and description thereof is omitted. The electrolytic capacitor element 10 includes a wound body 100 in which an anode foil 101, a cathode foil 102, and separators (electrolytic paper) 103 are wound, and a pair of extraction electrodes 19 connected to the anode foil 101 and the cathode foil 102.

The pair of extraction electrodes 19 extends downward from the wound body 100 in the height direction of the aluminum electrolytic capacitor 1. The round rod portion 111 of each extraction electrode 19 is connected to a corresponding one of the anode foil 101 and the cathode foil 102. Note that FIG. 2 illustrates a state before the lead portions 110 are bent.

The anode foil 101 and the cathode foil 102 are made of, for example, a valve metal, such as aluminum, tantalum, titanium, or niobium, an alloy foil thereof, a vapor-deposited foil, or the like. The surface of the anode foil 101 is subjected to etching treatment to increase the electrode area. This ensures that the electrolytic capacitor element 10 has a predetermined capacitance. Furthermore, an extremely thin oxide film is formed on the surface of the anode foil 101. Thus, the anode foil 101 is insulated from other members. The oxide film functions as a dielectric, allowing the electrolytic capacitor element 10 to function as a capacitor. The thickness of the anode foil 101 is, for example, 5 to 200 (μm). This thickness range is preferred because an appropriate balance relationship can be achieved between the strength of the anode foil 101 and the amount of developed capacity.

In contrast, no oxide film is formed on the surface of the cathode foil 102. The surface of the cathode foil 102 may also be subjected to etching treatment. In addition, an oxide film, an inorganic layer, or a carbon layer may be formed on the surface of the cathode foil 102.

Each of the separators 103 is wound while interposed between the anode foil 101 and the cathode foil 102. Each separator 103 is made of at least one or more materials selected from cellulose, rayon, glass fiber, and the like. The wound body 100 is a roughly columnar shape element formed by winding the anode foil 101, the cathode foil 102, and the separators 103 in a predetermined winding direction. In the present embodiment, the height direction of the electrolytic capacitor element 10 is defined along the height of this roughly columnar shape. The height direction is an example of a roughly orthogonal direction that is roughly orthogonal to a direction in which the wound body 100 is wound, and substantially coincides with a direction in which the round rod portion 111 of each extraction electrode 19 extends.

In the production process for the aluminum electrolytic capacitor 1, the wound body 100 is immersed in a dispersion liquid or solution of a conductive polymer (hereinafter, referred to as a conductive polymer liquid). The conductive polymer liquid is an example of a liquid containing the conductive polymer. The thickness of each separator 103 is, for example, 1 to 100 (μm). This thickness range is preferred because it maintains a good balance between the strength, insulating properties, porosity, and conductive material of the separator 103. As described below, it is preferable to form a conductive polymer layer toward the middle portion of the electrolytic capacitor element 10 using the conductive polymer liquid in such a manner that agglomerates are formed as narrow as possible in the height direction of the electrolytic capacitor element, and to perform impregnation with the electrolyte solution after the conductive polymer layer is formed.

The electrolyte solution can contain a polyhydric alcohol, a sulfone compound, a lactone compound, a carbonate compound, a diether compound of a polyhydric alcohol, a monohydric alcohol, or the like. These may be used alone or in combination of multiple types.

The polyhydric alcohol desirably includes, for example, at least one of ethylene glycol, diethylene glycol, triethylene glycol, propylene glycol, butanediol, polyalkylene glycol, and glycerin. As the polyalkylene glycol, it is preferable to use a polyethylene glycol having an average molecular weight of 200 to 1,000 or a polypropylene glycol having an average molecular weight of 200 to 5,000.

As the lactone compound, γ-butyrolactone, γ-valerolactone, and the like can be used. As the carbonate compound, dimethyl carbonate, diethyl carbonate, ethyl methyl carbonate, ethylene carbonate, propylene carbonate, fluoroethylene carbonate, or the like can be contained as a solvent. In particular, ethylene glycol, polyalkylene glycol, γ-butyrolactone, or sulfolane is preferably used.

The electrolyte solution may contain a solute. As the solute, an acid component, a base component, a salt composed of an acid component and a base component, a nitro compound, a phenol compound, and the like can be used.

As the acid component, an organic acid, an inorganic acid, or a composite compound of an organic acid and an inorganic acid can be used. As the organic acid, carboxylic acids, such as phthalic acid, isophthalic acid, terephthalic acid, maleic acid, succinic acid, glutaric acid, adipic acid, benzoic acid, 4-hydroxybenzoic acid, 1,6-decanedicarboxylic acid, 1,7-octanedicarboxylic acid, and azelaic acid, can be used. As the inorganic acid, boric acid, phosphoric acid, phosphorous acid, hypophosphorous acid, phosphoric esters, phosphoric diesters, and the like can be used.

As the composite compound of an organic acid and an inorganic acid, borodisalicylic acid, borodioxalic acid, and borodiglycolic acid can be used.

As the base component, primary to tertiary amines, quaternary ammonium, quaternized amidinium, and the like can be used. As the primary to tertiary amines, for example, methylamine, dimethylamine, trimethylamine, ethylamine, diethylamine, triethylamine, ethylenediamine, N,N-diisopropylethylamine, tetramethylethylenediamine, hexamethylenediamine, aniline, and the like can be used. As the quaternary ammonium, for example, tetramethylammonium, triethylmethylammonium, tetraethylammonium, and the like can be used. As the quaternized amidinium, for example, ethyldimethylimidazolinium, tetramethylimidazolinium, and the like can be used.

The conductive polymer is not particularly limited as long as it is a polymer having conductivity. For example, as the conductive polymer, for example, at least one polymer selected from the group consisting of polythiophene, polypyrrole, polyaniline, and derivatives thereof is used. As the conductive polymer, polyethylenedioxythiophene (PEDOT) containing at least one acid selected from the group consisting of p-toluenesulfonic acid, polystyrenesulfonic acid (PSS), and the like as a dopant is typically used.

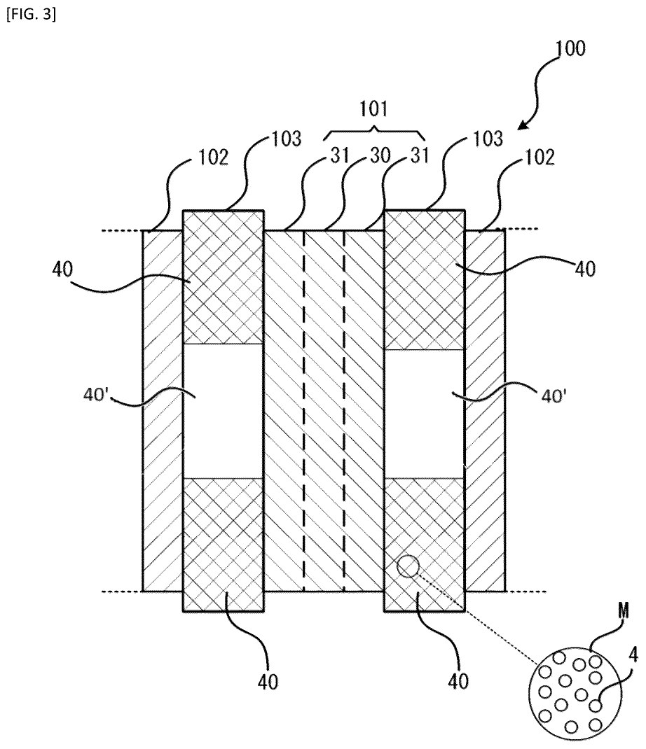

FIG. 3 is a cross-sectional view illustrating a part of a cross-section taken along line A-A in FIG. 2. Each of the separators 103 is interposed between the anode foil 101 and the cathode foil 102. The anode foil 101 includes etched layers 31 adjacent to the separators 103 on both sides, and an aluminum layer 30 between the etched layers 31.

On the surfaces of the etching layers 31 adjacent to the separators 103, dielectric layers, which are oxide films, are formed. In each dielectric layer, a large number of small holes called pits or the like are formed by etching treatment. In the production process for the aluminum electrolytic capacitor 1, when the electrolytic capacitor element 10 is immersed in the electrolyte solution, not only the insides of the separators 103 but also the insides of the pits are filled with the electrolyte solution.

Prior to the immersion in the electrolyte solution, conductive polymer immersion treatment is performed. When the electrolytic capacitor element 10 is immersed in the conductive polymer dispersion liquid, the separators 103 are impregnated with the conductive polymer dispersion liquid, and a large number of nanoparticles 4 of the conductive polymer are held. A large number of nanoparticles 4 are held at the upper and lower portions of each separator 103 in the height direction. After the electrolytic capacitor element 10 is immersed in the dispersion liquid or solution of the conductive polymer, the electrolytic capacitor element 10 is dried. This allows the nanoparticles 4 to aggregate, thereby forming conductive polymer layers 40, as illustrated in an enlarged view M.

However, there is a possibility that the separators 103 are not sufficiently impregnated with the conductive polymer liquid, thereby leading to insufficient formation of the conductive polymer layers 40.

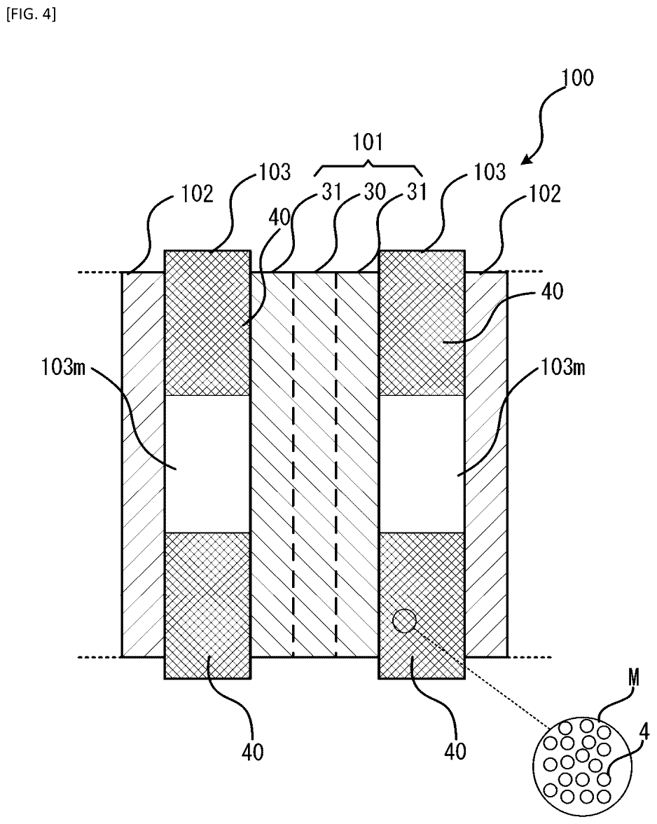

FIG. 4 is a cross-sectional view illustrating a part of a cross-section taken along line A-A in FIG. 2 when the conductive polymer layers 40 are not sufficiently formed. In FIG. 4, the same components as those in FIG. 3 are denoted by the same reference numerals, and description thereof is omitted.

The middle portions 103m of the separators 103 in the height direction are not sufficiently impregnated with the conductive polymer liquid; thus, the nanoparticles 4 hardly reach the middle portions, and the conductive polymer layer 40 is not formed after the separators 103 are dried. The conductive polymer layers 40 are formed only at both end portions of each separator 103 in the height direction in a state where the density of the nanoparticles 4 is higher than that in the case of FIG. 3. The conductive polymer layer 40 thins from the upper and lower portions of each separator 103 toward the middle portion 103m in the height direction.

Thus, the middle portion 103m of each separator 103 in the height direction has a higher resistance than both end portions thereof, and the amount of heat generated is also higher. In contrast, as illustrated in FIG. 3, when the conductive polymer layer 40 is formed over the entirety of each separator 103 in the height direction, the resistance is substantially uniform in the height direction. Thus, the ESR of aluminum electrolytic capacitor 1 decreases as the area where the conductive polymer layer 40 is formed increases. It should be noted that the electrolyte solution is present in the middle portion 103m of each separator 103 in the height direction even when the conductive polymer layer 40 is not present. For this reason, the capacitance of the aluminum electrolytic capacitor 1 is not substantially different from that in the case of FIG. 3. However, the properties may deteriorate due to the evaporation of the electrolyte solution.

The inventors have found that when the thin band-shaped agglomerates of the conductive polymer having a certain width or less are formed at the end portions of the electrolytic capacitor element 10, a larger amount of conductive polymer enters the middle portion of the electrolytic capacitor element 10 due to a sealing effect against the polymer dispersion liquid, and the ESR and the like of the aluminum electrolytic capacitor 1 can be reduced.

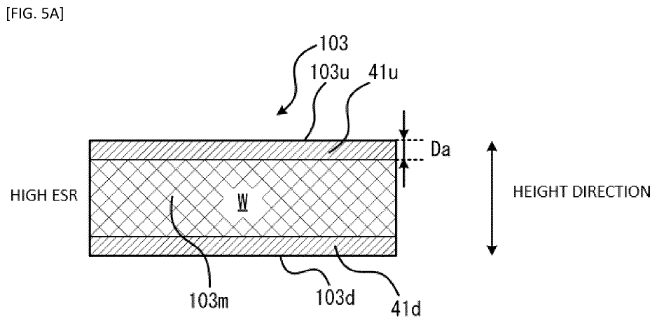

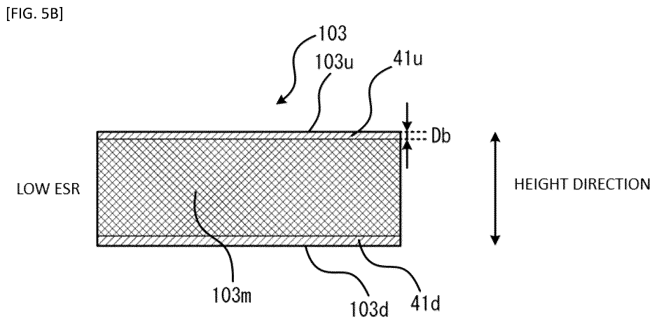

FIG. 5A is a plan view illustrating a surface of the separator 103 when the ESR is high. FIG. 5B is a plan view illustrating a surface of the separator 103 when the ESR is low. In each of FIGS. 5A and 5B, the separator 103 has a roughly rectangular shape, and is illustrated in a state in which it is decomposed from the wound body 100 and developed in the longitudinal direction. In the middle portion 103m of the separator 103, many conductive polymer nanoparticles 4 are present in a narrow mesh region. In contrast, there are fewer nanoparticles 4 of the conductive polymer in a wide mesh region.

In either case, at both end portions 103u and 103d of the separator 103 in the height direction, band-shaped agglomerates 41u and 41d of the conductive polymer are formed along the end portions 103u and 103d, respectively. In the agglomerates 41u and 41d, more nanoparticles 4 are densely formed than in the other portions of the separator 103. In addition, the agglomerates 41u and 41d are formed in a linear shape while a constant distance is maintained from the end portions 103u and 103d of the separator 103.

If the width of the agglomerates 41u and 41d in the height direction when the ESR is high is Da (mm), and if the width of the agglomerates 41u and 41d in the height direction when the ESR is low is Db (mm), then the relationship Da>Db holds. That is, when the ESR is low, the width of each of the agglomerates 41u and 41d in the height direction is narrower.

The middle portion 103m of the separator 103 in the height direction is compared between the above two cases. When the ESR is high, a region W where the number of nanoparticles 4 is extremely small is formed in the middle portion 103m. However, when the ESR is low, such a region W is not present, and the nanoparticles 4 are distributed substantially uniformly. When the ESR is high, since the agglomerates 41u and 41d having a large width are formed at both end portions 103u and 103d of the separator 103, many nanoparticles 4 are accumulated at both end portions 103u and 103d, and the number of nanoparticles 4 at the middle portion 103m is decreased. In contrast, when the ESR is low, since the agglomerates 41u and 41d having a narrow width are formed at both end portions 103u and 103d of the separator 103, the number of nanoparticles 4 in the middle portion 103m is increased.

Thus, the narrower widths (Da and Db) of the agglomerates 41u and 41d lead to uniform impregnation of the separator 103 with the conductive polymer in the height direction, thereby resulting in a low ESR. When the width of each of the agglomerates 41u and 41d is 3 (mm) or less, the ESR is sufficiently reduced. More preferably, the width of each of the agglomerates 41u and 41d may be 2 (mm) or less, or 1 (mm) or less.

Also, in this example, the agglomerates 41u and 41d are formed along both end portions 103u and 103d of the separator 103 in the height direction. Thus, in the production process for the aluminum electrolytic capacitor 1, when the wound body 100 is immersed in the conductive polymer liquid, the agglomerates 41u and 41d are formed so as to have a narrow width. This can inhibit the uneven formation of the conductive polymer layer and reduce the ESR of the aluminum electrolytic capacitor 1.

Since the separator 103 overlaps the anode foil 101 and the cathode foil 102, the agglomerates 41u and 41d of the separator 103 are attached to the opposing surfaces of the anode foil 101 and the cathode foil 102.

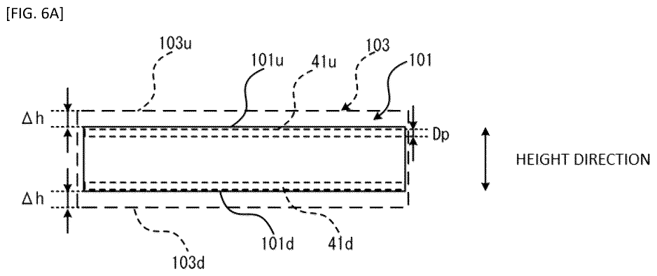

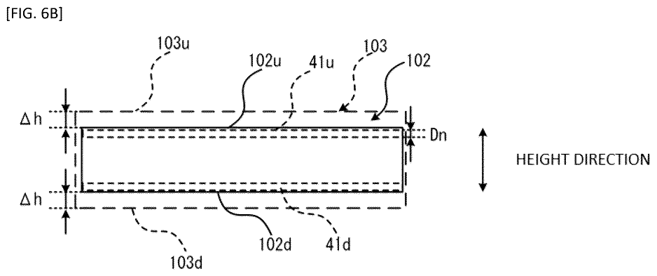

FIG. 6A is a plan view illustrating the anode foil 101 decomposed from the wound body 100. FIG. 6B is a plan view illustrating the cathode foil 102 decomposed from the wound body 100. Here, the anode foil 101 and the cathode foil 102 have a roughly rectangular shape, and are developed in the longitudinal direction while overlapping with the separator 103 (see dotted line). The width of the separator 103 in the height direction is greater than the width of the anode foil 101 and the cathode foil 102 in the height direction. Thus, in the height direction, both end portions 103u and 103d of the separator 103 are shifted outward by a difference Δh from both end portions 101u and 101d of the anode foil 101 and from both end portions 102u and 102d of the cathode foil 102.

The agglomerates 41u and 41d of the nanoparticles 4 formed on the separator 103 are attached to the anode foil 101 and the cathode foil 102 along both end portions 103u and 103d of the separator 103, respectively. For this reason, the electrical path between the anode foil 101 and the cathode foil 102 through the agglomerates 41u and 41d on the separator 103 is shortened, thereby resulting in a reduction in ESR. Also, since the separator 103 is firmly connected to the anode foil 101 and the cathode foil 102, separation from the anode foil 101 and the cathode foil 102 is inhibited.

The anode foil 101 and the cathode foil 102 are wound in a state of being roughly parallel to and overlapping with the separator 103. Thus, the agglomerates 41u and 41d attached to the anode foil 101 and the cathode foil 102 extend along both end portions 101u and 101d of the anode foil 101 and both end portions 102u and 102d of the cathode foil 102.

The width Dp in the height direction of the agglomerates 41u and 41d of the nanoparticles 4 attached to the anode foil 101 and the width Dn in the height direction of the agglomerates 41u and 41d of the nanoparticles 4 attached to the cathode foil 102 are determined according to the width of the agglomerates 41u and 41d on the separator 103 and the above-described difference Δh. Specifically, the widths Dp and Dn of the agglomerates 41u and 41d on the anode foil 101 and the cathode foil 102 are calculated by subtracting the difference Δh from the widths of the agglomerates 41u and 41d on the separator 103, respectively. As with the separator 103, narrower widths Dp and Dn of the agglomerates 41u and 41d result in a larger number of the nanoparticles 4 of the conductive polymer attached to the middle portions of the anode foil 101 and cathode foil 102 in the height direction.

### (Production Process for Aluminum Electrolytic Capacitor)

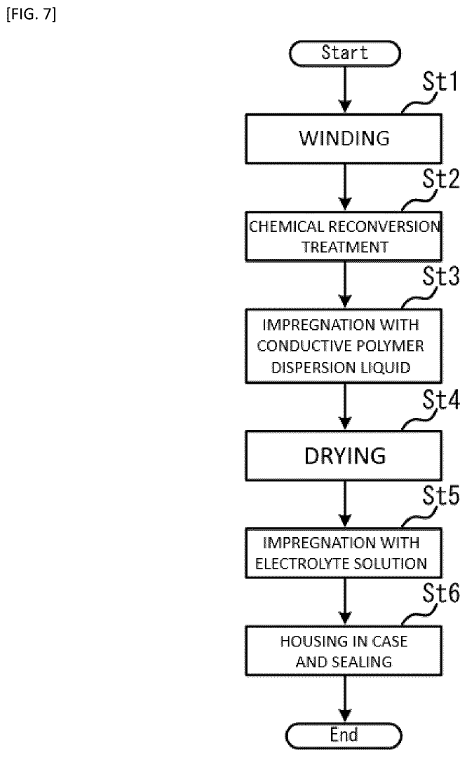

FIG. 7 is a flowchart illustrating an example of a production process for the aluminum electrolytic capacitor 1. In producing the aluminum electrolytic capacitor 1, the anode foil 101, the cathode foil 102, the separators 103, and the like are provided. For example, the thickness of the anode foil 101 is 5 to 200 (μm), and the thickness of each separator is 1 to 100 (μm). Pits may be formed on the surfaces of the anode foil 101 and the cathode foil 102 by etching treatment. The anode foil 101 is subjected to a chemical conversion treatment to form a dielectric layer of an oxide film on the surface that has been subjected to etching treatment. Also, the pair of extraction electrodes 19 is connected to the respective anode and cathode foils 101 and 102. An example of means for connecting the extraction electrodes 19 is caulking, but the present invention is not limited thereto.

First, the anode foil 101, the separator 103, the cathode foil 102, and the separator 103 are stacked in this order and wound. The outer surface is fixed with a winding-head fixing tape to form the wound body 100 (step St1).

Next, the wound body 100 is immersed in, for example, an aqueous ammonium phosphate solution. The anode foil 101 is subjected to chemical reconversion treatment while a predetermined voltage is applied to the anode foil 101, thereby repairing the oxide film and forming a dielectric layer on the surface and the cut end of the anode foil 101 (step St2).

Next, in a reduced-pressure atmosphere, the wound body 100 is immersed in a dispersion liquid of a conductive polymer, and the wound body 100 is impregnated with the dispersion liquid (step St3). It should be noted that instead of the dispersion liquid of the conductive polymer, the wound body 100 may be immersed in a solution containing a conductive polymer. A method for immersing the wound body 100 in the conductive polymer liquid will be described below.

Next, the wound body 100 is dried (step St4). At this time, water serving as a solvent of the conductive polymer liquid with which the separators 103 in the wound body 100 have been impregnated evaporates, and the nanoparticles 4 form the conductive polymer layers 40.

Next, the electrolytic capacitor element 10 is impregnated with an electrolyte solution in a reduced-pressure atmosphere (step St5). Next, the electrolytic capacitor element 10 is housed in the case 11 and sealed with the sealing body 12 (step St6). At this time, the extraction electrodes 19 extending from the electrolytic capacitor element 10 are inserted into the through holes 120 of the sealing body 12. Thereafter, aging treatment may be performed while a rated voltage is applied to the aluminum electrolytic capacitor 1. The production process for the aluminum electrolytic capacitor 1 is performed in this manner.

### (Method for Immersing Electrolytic Capacitor Element)

In step St3 above, a method for immersing the wound body 100, that is, the electrolytic capacitor element 10 (hereinafter, an electrolytic capacitor element 10a) prior to immersion in the conductive polymer liquid and the electrolyte solution, in the conductive polymer liquid will be described. It should be noted that in the following embodiment, the dispersion liquid of the conductive polymer is exemplified, but the immersion method is similar to that in the case of a solution of a conductive polymer.

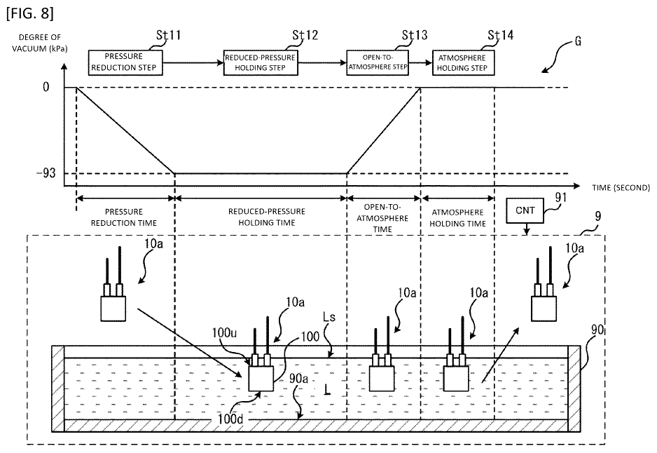

FIG. 8 is a diagram illustrating a method for immersing the electrolytic capacitor element 10a. In FIG. 8, a section of a reservoir 90, in the vertical direction, installed in a vacuum chamber 9, and the electrolytic capacitor element 10a are illustrated. The electrolytic capacitor element 10a is immersed in a dispersion liquid L of the conductive polymer stored in the reservoir 90 in such a manner that the separators 103 are impregnated with the conductive polymer.

A pressure control device (CNT) 91 controls the pressure in the vacuum chamber 9 with, for example, a vacuum pump (not illustrated). Specifically, the pressure control device 91 controls the degree of vacuum (kPa) in the vacuum chamber 9 over time, as indicated by the symbol G. The degree of vacuum is a relative pressure when the atmospheric pressure around the vacuum chamber 9 is set to 0 (kPa). In the present embodiment, as an example, when the degree of vacuum is −93 (kPa), the inside of vacuum chamber 9 is defined as substantially vacuum.

The pressure control device 91 performs a pressure reduction step St11, a reduced-pressure holding step St12, an open-to-atmosphere step St13, and an atmosphere holding step St14 in that order. The graph of the symbol G illustrates a temporal change in the degree of vacuum together with a pressure reduction time, a reduced-pressure holding time, an open-to-atmosphere time, and an atmosphere holding time which are the required times of the pressure reduction step St11, the reduced-pressure holding step St12, the open-to-atmosphere step St13, and the atmosphere holding step St14. Also, the position of the electrolytic capacitor element 10a relative to the reservoir 90 is also illustrated for each step.

The pressure reduction step St11 is an example of a step of reducing the pressure in the vacuum chamber 0 to create a substantially vacuum state. In the pressure reduction step St11, the pressure control device 91 reduces the degree of vacuum in the vacuum chamber 9 from 0 (kPa) of the atmospheric pressure to vacuum (−93 (kPa)) in a predetermined pressure reduction time. The pressure reduction time is, for example, 60 (seconds). Also, the value of the pressure reduction per unit time is constant. By the pressure reduction step St11, the inside of the vacuum chamber 9 is substantially in a vacuum state.

During the implementation of the pressure reduction step St11, the electrolytic capacitor element 10a is held outside the conductive polymer dispersion liquid L in the vacuum chamber 9. That is, the electrolytic capacitor element 10a is not immersed in the dispersion liquid L. Thus, according to this step, air can be removed from the inside of the electrolytic capacitor element 10a before immersion in the dispersion liquid L, so that the dispersion liquid L can be smoothly introduced into the electrolytic capacitor element 10a in the subsequent step.

In contrast, if the electrolytic capacitor element 10a is maintained in a state of being immersed in the dispersion liquid L during the implementation of the pressure reduction step St11, the dispersion liquid L will be foamed when air escapes from the electrolytic capacitor element 10a. Thus, the dispersion liquid L intermittently enters the electrolytic capacitor element 10a, and there is a possibility that the separator 103 cannot be sufficiently impregnated with the conductive polymer.

In the reduced-pressure holding step St12, the electrolytic capacitor element 10a is immersed in the dispersion liquid L, and the inside of the vacuum chamber 9 is maintained in a vacuum state for the reduced-pressure holding time. In this step, the wound body 100 of the electrolytic capacitor element 10a is completely immersed in the dispersion liquid L. At this time, the wound body 100 is held in an attitude in which a lower surface 100d faces the bottom surface 90a of the reservoir 90 and an upper surface 100u is maintained roughly parallel to the liquid surface Ls of the dispersion liquid L.

While the electrolytic capacitor element 10a is immersed in the dispersion liquid L, the pressure control device 91 maintains the degree of vacuum at −93 (kPa). Since the separators 103 are interposed between the anode foil 101 and the cathode foil 102 in the wound body 100, the dispersion liquid L is introduced from both end portions of each separator 103 in the height direction toward the middle portion by capillary action. The reduced-pressure holding time is, for example, 300 (seconds) or less.

In the open-to-atmosphere step St13, while the electrolytic capacitor element 10a is immersed in the dispersion liquid L, the inside of the vacuum chamber 9 is brought to the atmospheric pressure, which is a pressure before the pressure is reduced to the vacuum state during the open-to-atmosphere time. In this step, the wound body 100 is maintained in a state of being immersed in the dispersion liquid L continuously from the reduced-pressure holding step St12. With the wound body 100 still immersed, the pressure control device 91 naturally increases the degree of vacuum to 0 (kPa) by opening to the atmosphere. At this time, the value of an increase in pressure per unit time is substantially constant. Also, the open-to-atmosphere time is, for example, 40 (seconds) or less. Moreover, in the open-to-atmosphere step St13, the inside of the vacuum chamber 9 may be pressurized with a pump or the like to bring the pressure to atmospheric pressure, which is a pressure before the pressure reduction.

In the atmosphere holding step St14, while the electrolytic capacitor element 10a is immersed in the dispersion liquid L, the inside of the vacuum chamber 9 is held at atmospheric pressure for an atmospheric pressure holding time. After the atmosphere holding time has elapsed, the electrolytic capacitor element 10a is pulled up from the dispersion liquid L. The atmosphere holding time is, for example, 6 (seconds), but is not limited thereto. Through the above steps, the separators 103 of the electrolytic capacitor element 10a are impregnated with the conductive polymer.

Appropriate adjustment of at least one of the reduced-pressure holding time and the open-to-atmosphere time described above can result in narrower widths (Da and Db) of the agglomerates 41u and 41d of the conductive polymer and impregnation of the middle portions or vicinities of the separators 103 in the height direction with the conductive polymer. The impregnation process in the reduced-pressure holding step St12 and the open-to-atmosphere step St13 are described below.

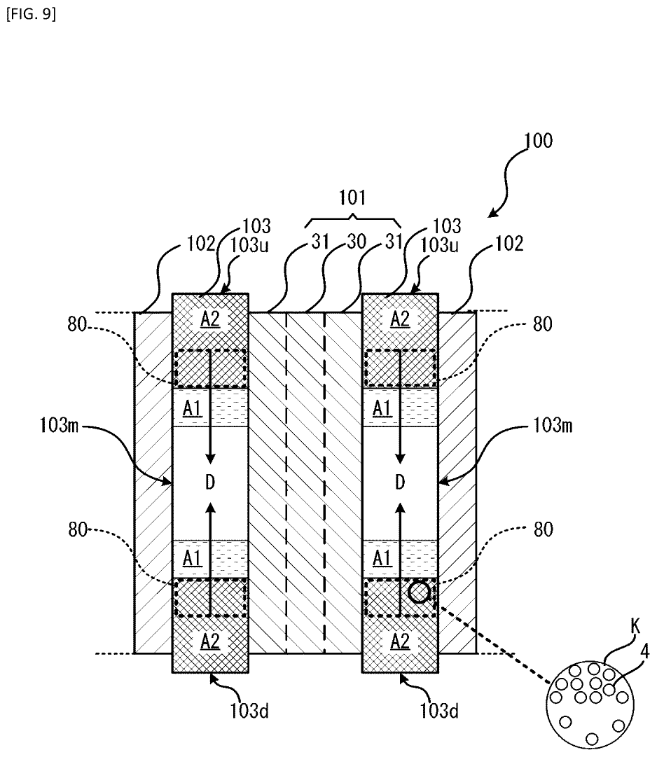

FIG. 9 is a cross-sectional view of the wound body 100 and illustrates an example of a state in which the separators 103 are impregnated with a dispersion liquid of a conductive polymer in a reduced-pressure holding step St12. In FIG. 9, the same components as those in FIG. 3 are denoted by the same reference numerals, and description thereof is omitted.

In the separators 103, regions A1 hatched with multiple straight lines indicate regions impregnated with water serving as the solvent separated from the dispersion liquid, and regions A2 hatched with shading indicate regions impregnated with the dispersion liquid. In the separators 103, the colorless regions indicate regions that are not impregnated with either water or the dispersion liquid.

However, in each separator 103, the impregnation speed of the nanoparticles 4 of the conductive polymer and the solvent differs from each other. For this reason, when the impregnation proceeds to a certain extent, the solvent (e.g., water) in the conductive polymer liquid first reaches the middle portion 103m of the separator in the height direction. This makes it difficult for the conductive polymer to reach the middle portion 103m of the separator which is filled with the preceding solvent, and as a result, accumulation regions 80 in which large amounts of the nanoparticles 4 of the conductive polymer have accumulated are formed on both end portions 103u and 103d. Reference symbol K indicates an enlarged view of the vicinity of the boundary between the accumulation region 80 and other regions. In the accumulation region 80, the nanoparticles 4 are present at a higher density than in other regions.

For this reason, only water serving as the solvent is separated from the dispersion liquid and flows beyond the accumulation regions 80 toward the middle portion 103m of each separator in the height direction, making it difficult for the nanoparticles 4 to reach the middle portion 103m of the separator. After the drying step St4, the accumulation regions 80 extend to both end portions 103u and 103d in the height direction to form the agglomerates 41u and 41d of the conductive polymer.

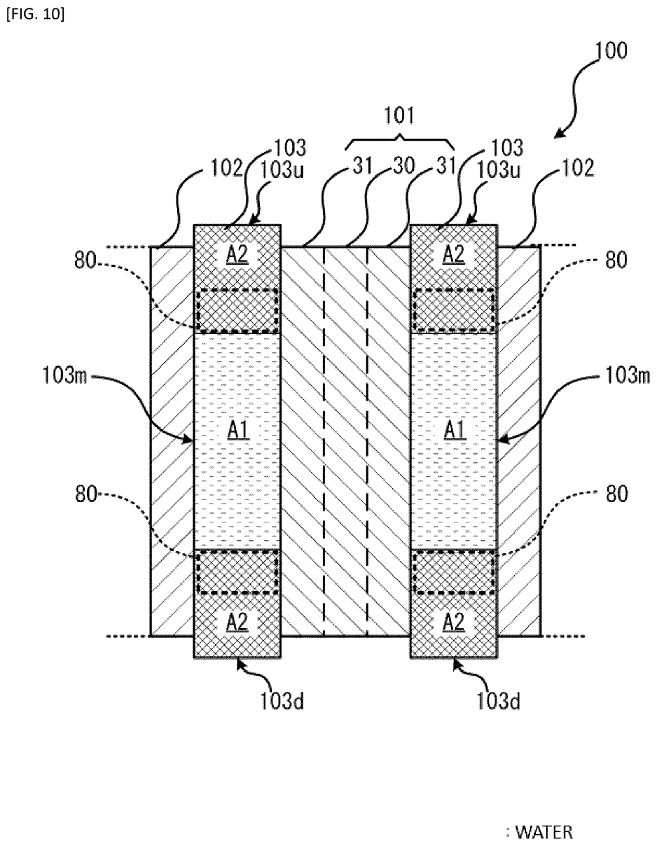

FIG. 10 is a cross-sectional view illustrating an example of the wound body 100 in which the separators 103 are not sufficiently impregnated with the dispersion liquid. In FIG. 10, the same components as those in FIG. 9 are denoted by the same reference numerals, and description thereof is omitted. As described above, when the accumulation regions 80 of the nanoparticles 4 are formed in each separator 103, only the water separated from the dispersion liquid passes over the accumulation regions 80 and reaches the middle portion 103m of the separator 103 in the height direction.

For this reason, the distribution of the nanoparticles 4 is biased toward both end portions 103u and 103d of the separator 103 in the height direction. In a region closer to the middle portion 103m of the separator 103, the nanoparticles 4 are less present. Thus, as illustrated in FIG. 4, the conductive polymer layers 40 are formed with a biased distribution at both end portions 103u and 103d of the separator 103. Therefore, the ESR of the aluminum electrolytic capacitor 1 is higher than when the nanoparticles 4 are uniformly distributed in the height direction of the separator 103.

In contrast, for example, when the reduced-pressure holding step St12 is shortened from the example of FIG. 10 to inhibit the formation of the accumulation regions 80 of the nanoparticles 4 and the open-to-atmosphere step St13 is started, the nanoparticles 4 can be uniformly distributed in the height direction of the separator 103.

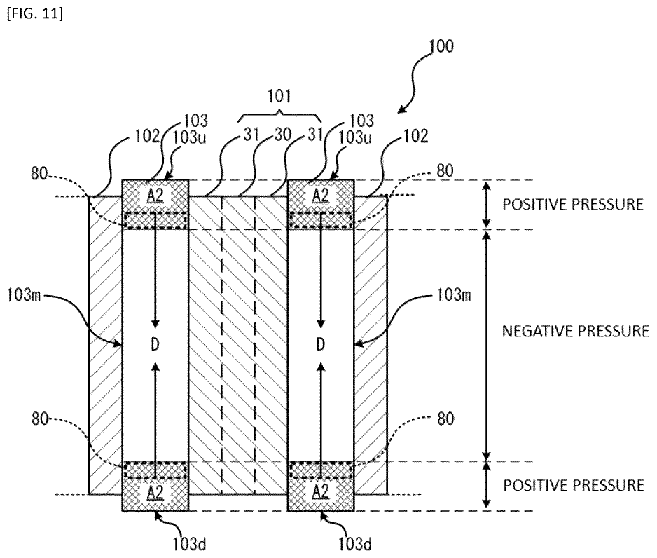

FIG. 11 is a cross-sectional view of the wound body 100 and illustrates an example of the impregnation state of the dispersion liquid when the open-to-atmosphere step St13 is started with the formation of the accumulation regions 80 of the nanoparticles 4 inhibited. In FIG. 11, the same components as those in FIG. 9 are denoted by the same reference numerals, and description thereof will be omitted. In this example, compared with the example of FIG. 10, impregnation with the dispersion liquid does not proceed, and the impregnated regions are far from the middle portion 103m of each separator 103, and the length in the height direction is short. Furthermore, the formation of the accumulation regions 80 are inhibited as compared to the example of FIG. 10. Therefore, the width of each accumulation region 80 in the height direction is narrow, and the width of each of the conductive polymer agglomerates 41u and 41d after drying is also narrow.

In the open-to-atmosphere step St13, the pressure inside the vacuum chamber 9 is brought to atmospheric pressure, so that a negative pressure is generated in the region of each separator 103 on the side of the middle portion 103m where no dispersion liquid is present, and a positive pressure is generated in regions on the sides of both end portions 103u and 103d impregnated with the dispersion liquid. Thus, due to the pressure difference between the region on the side of the middle portion 103m and the regions on the sides of both end portions 103u and 103d (hereinafter, referred to as an inter-region pressure difference), the dispersion liquid moves beyond the accumulation regions 80, where the formation is inhibited, toward the middle portion 103m, as indicated by arrows D. The use of the inter-region pressure difference enables the nanoparticles 4 of the conductive polymer to be distributed from the both end portions 103u and 103d to the middle portion 103m.

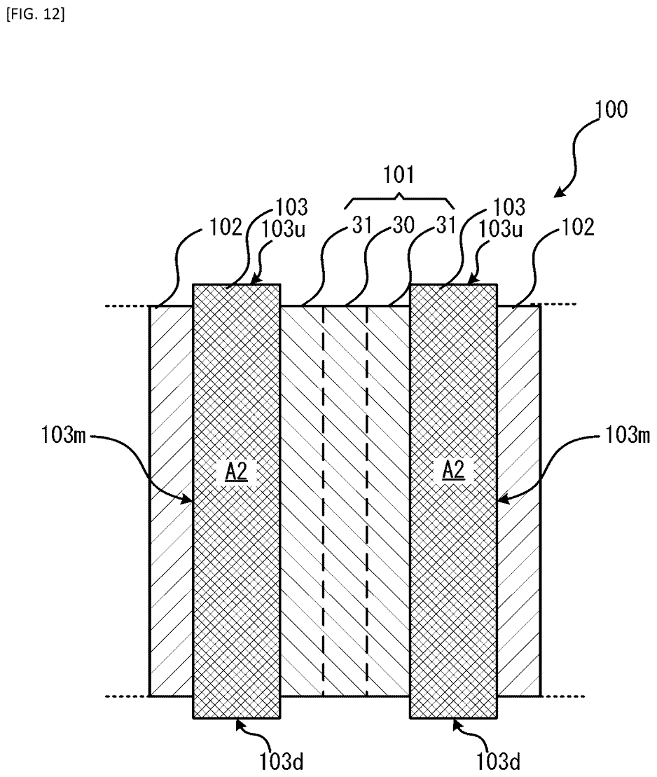

FIG. 12 is a cross-sectional view illustrating an example of the wound body 100 in which the separators 103 are ideally impregnated with a dispersion liquid. In FIG. 12, the same components as those in FIG. 9 are denoted by the same reference numerals, and description thereof will be omitted. In this example, each separator 103 is impregnated with the dispersion liquid from both end portions 103u and 103d to the middle portion 103m. Thus, the nanoparticles 4 can be uniformly distributed in each separator 103 in the height direction. As illustrated in FIG. 3, the conductive polymer layers 40 can be formed over the entirety of each separator 103 in the height direction.

As described above, when the separators 103 are impregnated with the dispersion liquid, the formation of the accumulation regions 80 of the nanoparticles 4 in each separator 103 can be inhibited by appropriately adjusting the reduced-pressure holding time and the open-to-atmosphere time, and the nanoparticles 4 can be substantially uniformly distributed over the entirety of the separator 103 in the height direction by utilizing the inter-region pressure difference. When the subsequent drying step St4 is performed, the agglomerates 41u and 41d of the conductive polymer are formed in the accumulation regions 80 of the separators 103, as illustrated in FIGS. 5A and 5B. Thus, the formation of the accumulation regions 80 are inhibited, thereby narrowing the width of the agglomerates 41u and 41d in the height direction. This inhibits uneven formation of the conductive polymer layers, thereby reducing the ESR of the aluminum electrolytic capacitor 1.

### Examples

According to the above production steps, 100 pieces each of Sample Nos. 1 to 16 of aluminum electrolytic capacitor 1 were produced. Here, the difference Δh between the positions of both end portions 103u and 103d of the separator 103 and the positions of both end portions 101u and 101d of the anode foil 101 and the positions of both end portions 102u and 102d of the cathode foil 102 was set to 0.5 (mm). The rated voltage and the rated capacitance of Sample Nos. 1 to 8 were 63 (V) and 33 (μF), respectively. The rated voltage and the rated capacitance of Sample Nos. 9 to 16 were 25 (V) and 1,000 (μF), respectively. The case size of Sample Nos. 1 to 8 was 8 (mm) in diameter and 10 (mm) in length. The case size of Sample Nos. 9 to 18 was 12.5 (mm) in diameter and 16.5 (mm) in length.

Ten pieces each of the produced Sample Nos. 1 to 18 were decomposed, and the widths of the agglomerates 41u and 41d of the conductive polymer in the height direction and the ESR (average value) were measured. The widths of the agglomerates 41u and 41d were measured with a laser microscope. Regarding the ESR, the ESR (initial ESR) (mΩ) of the aluminum electrolytic capacitor 1 at a frequency of 100 kHz was measured with an LCR meter for four-terminal measurement.

### (Sample Nos. 1 to 8)

The widths of the agglomerates 41u and 41d of the conductive polymer formed on the separators 103, the anode foils 101, and the cathode foils 102, and the ESRs were evaluated using Sample Nos. 1 to 8.

TABLE 1

| | Width of agglomerate (mm) | | | | | Determi- |
|---|---|---|---|---|---|---|
| Sample | Sepa- | Anode | Cathode | ESR | ESR | nation |
| No. | rator | foil | foil | (mΩ) | ratio | result |
| 1 | 0.6 | 0.1 | 0.1 | 13.8 | 0.817 | ∘ |
| 2 | 1.0 | 0.5 | 0.5 | 13.9 | 0.822 | ∘ |
| 3 | 1.5 | 1.0 | 1.0 | 13.9 | 0.822 | ∘ |
| 4 | 2.0 | 1.5 | 1.5 | 14.1 | 0.834 | ∘ |
| 5 | 2.5 | 2.0 | 2.0 | 14.3 | 0.846 | ∘ |
| 6 | 3.0 | 2.5 | 2.5 | 14.9 | 0.882 | ∘ |
| 7 | 3.5 | 3.0 | 3.0 | 16.9 | 1 | x |
| 8 | 4.0 | 3.5 | 3.5 | 17.5 | 1.036 | x |

Table 1 presents the evaluation results of Sample Nos. 1 to 8. Table 1 presents the widths of the agglomerates 41u and 41d on the separators 103, the anode foils 101, and the cathode foils 102, the ESR, the ESR ratios, and the determination results of Sample Nos. 1 to 8. The ESR ratios are the ratios of the ESRs of Sample Nos. 1 to 6 and 8 to the ESR of Sample No. 7, which is 16.9 (mΩ). The determination results of Sample Nos. 1 to 6, where the ESR ratios were less than 1, were evaluated as “∘”, while the results of the determination of Sample Nos. 7 and 8, where the ESRs were 1 or more, were evaluated as “x”.

Narrower widths of the agglomerates 41u and 41d resulted in smaller ESRs and ESR ratios. In Sample Nos. 1 to 6, where the widths of the agglomerates 41u and 41d on the separators 103 were 3 (mm) or less, the ESR ratios were less than 1. In Sample Nos. 1 to 4, where the widths of the agglomerates 41u and 41d on the separators 103 were 2 (mm) or less, the ESR ratios were less than 0.84, which is preferable. In Sample Nos. 1 to 3, where the widths of the agglomerates 41u and 41d on the separators 103 were 1.5 (mm) or less, the ESR ratios were less than 0.83, which is more preferable.

In Sample Nos. 7 and 8, where the widths of the agglomerates 41u and 41d on the separators 103 were more than 3 (mm), the ESR ratios were 1 or more.

In Sample Nos. 1 to 8, the widths of the agglomerates 41u and 41d of the conductive polymer attached to the anode foils 101 and the cathode foils 102 were narrower than the widths of the agglomerates 41u and 41d on the separators 103 by a difference Δh of 0.5 (mm).

### (Sample Nos. 9 to 16)

The widths of the agglomerates 41u and 41d of the conductive polymer formed on the separators 103, the anode foils 101, and the cathode foils 102, and the ESRs were evaluated using Sample Nos. 9 to 16.

TABLE 2

| | Width of agglomerate (mm) | | | | | Determi- |
|---|---|---|---|---|---|---|
| Sample | Sepa- | Anode | Cathode | ESR | ESR | nation |
| No. | rator | foil | foil | (mΩ) | ratio | result |
| 9 | 0.6 | 0.1 | 0.1 | 3.7 | 0.661 | ∘ |
| 10 | 1.0 | 0.5 | 0.5 | 3.9 | 0.696 | ∘ |
| 11 | 1.5 | 1.0 | 1.0 | 4.1 | 0.732 | ∘ |
| 12 | 2.0 | 1.5 | 1.5 | 4.0 | 0.714 | ∘ |
| 13 | 2.5 | 2.0 | 2.0 | 4.2 | 0.750 | ∘ |
| 14 | 3.0 | 2.5 | 2.5 | 4.3 | 0.768 | ∘ |
| 15 | 3.5 | 3.0 | 3.0 | 5.6 | 1.000 | x |
| 16 | 4.0 | 3.5 | 3.5 | 6.0 | 1.071 | x |

Table 2 presents the evaluation results of Sample Nos. 9 to 16. Table 2 presents the widths of the agglomerates 41u and 41d on the separators 103, the anode foils 101, and the cathode foils 102, the ESR, the ESR ratios, and the determination results of Sample Nos. 9 to 16. The ESR ratios are the ratios of the ESRs of Sample Nos. 9 to 14 and 16 to the ESR of Sample No. 15, which is 5.6 (mΩ). The determination results of Sample Nos. 9 to 14, where the ESR ratios were less than 1, were evaluated as “∘”, while the results of the determination of Sample Nos. 15 and 16, where the ESRs were 1 or more, were evaluated as “x”.

Narrower widths of the agglomerates 41u and 41d resulted in smaller ESRs and ESR ratios. In Sample Nos. 9 to 14, where the widths of the agglomerates 41u and 41d on the separators 103 were 3 (mm) or less, the ESR ratios were less than 1. In Sample Nos. 9 to 12, where the widths of the agglomerates 41u and 41d on the separators 103 were 2 (mm) or less, the ESR ratios were less than 0.72, which is preferable. In Sample Nos. 9 and 10, where the widths of the agglomerates 41u and 41d on the separators 103 were 1.0 (mm) or less, the ESR ratios were less than 0.7, which is more preferable.

In Sample Nos. 15 and 16, where the widths of the agglomerates 41u and 41d on the separators 103 were more than 3 (mm), the ESR ratios were 1 or more.

Also, in Sample Nos. 9 to 16, the widths of the agglomerates 41u and 41d of the conductive polymer attached to the anode foils 101 and the cathode foils 102 were narrower than the widths of the agglomerates 41u and 41d on the separators 103 by a difference Δh of 0.5 (mm).

As described above, in the electrolytic capacitor element 10, the band-shaped agglomerates 41u and 41d of the conductive polymer having a width of 3 (mm) or less are formed along the end portions 103u and 103d of the separators 103 in the height direction. Thus, the separators 103 are impregnated with the conductive polymer dispersion liquid up to the middle portions 103m, and the nanoparticles 4 of the conductive polymer are substantially uniformly distributed throughout the separator 103 in the height direction. Therefore, the ESR of the aluminum electrolytic capacitor 1 is reduced.

Examples of the present invention are described in detail above. It should be noted that the present invention is not limited by the specific examples, and various modifications and changes can be made within the scope of the present invention which is described in the claims. For example, the present invention can be applied to a multilayer-type hybrid electrolytic capacitor having one or more pairs of flat capacitor elements in which an anode and a cathode face each other with a separator interposed therebetween, in which agglomerates are formed on part or all of the peripheral surface.

1. An electrolytic capacitor element, comprising:
a separator impregnated with a conductive polymer; and
an anode foil and a cathode foil facing each other via the separator,
wherein at an end portion of the separator in a height direction, a band-shaped agglomerate of the conductive polymer, having a width of 3 mm or less in the height direction, is formed along a periphery of the end portion.

2. The electrolytic capacitor element according to claim 1, wherein the separator, the anode foil, and the cathode foil are wound in a direction roughly orthogonal to the height direction, and
wherein at another end portion opposite to the end portion in the height direction, another band-shaped agglomerate of the conductive polymer having a width of 3 mm or less in the height direction is formed along a periphery of the another end portion.

3. The electrolytic capacitor element according to claim 1, wherein the agglomerate of the conductive polymer formed on the separator has a width of 2 mm or less in the height direction.

4. The electrolytic capacitor element according to claim 1, wherein the agglomerate of the conductive polymer formed on the separator has a width of 1 mm or less in the height direction.

5. The electrolytic capacitor element according to claim 1, wherein the band-shaped agglomerate of the conductive polymer is attached to the anode foil along an end portion of the anode foil in the height direction.

6. The electrolytic capacitor element according to claim 1, wherein the band-shaped agglomerate of the conductive polymer is attached to the cathode foil along an end portion of the cathode foil in the height direction.

7. An electrolytic capacitor, comprising the electrolytic capacitor element according to claim 1.
